(19) United States
(12) Patent Application Publication
(10) Pub. No.: US 2014/0262962 A1
(43) Pub. Date: Sep. 18, 2014

(54) HYDROCARBONS RECOVERY WITH SONIC TREATMENT

(71) Applicant: PetroSonic Energy Inc., Calgary (CA)

(72) Inventors: Art Agolli, Calgary (CA); Patrick Brunelle, Langdon (CA); Alfred Fischer, Calgary (CA)

(73) Assignee: PetroSonic Energy Inc., Calgary (CA)

(21) Appl. No.: 14/209,400

(22) Filed: Mar. 13, 2014

Related U.S. Application Data
(60) Provisional application No. 61/789,401, filed on Mar. 15, 2013.

(51) Int. Cl. C10G 32/00; B01J 19/10

(52) U.S. Cl. CPC C10G 32/00; B01J 19/10
USPC 208/309; 422/127

(57) ABSTRACT

The present disclosure refers to a method for hydrocarbon recovery from a variety of oil spills, using a proprietary sonic treatment process for removal of solids from hydrocarbon substances, to convert contaminated hydrocarbons into de-asphalted oil and heavy oil fuel output. This method may generally require a solvent for removal of material in suspension, which may dissolve contaminated hydrocarbons by using a plurality of alkane containing non polar solvents, which may be filtered through simple separation. The sonic treatment method may reduce the production time of de-asphalted oil and heavy oil fuel, from a range from about six hours up to more than ten hours to about two minutes up to 30 seconds depending on the solvent-feedstock mixture being processed.

### CROSS REFERENCE TO RELATED APPLICATIONS

This application claims priority to U.S. Provisional Patent Application Ser. No. 61/789,401, filed Mar. 15, 2013, entitled “Hydrocarbons Recovery with Sonic Treatment,” which is hereby incorporated by reference in its entirety.

### BACKGROUND

1. Field of the disclosure

The present disclosure relates generally to oil contaminated site remediation and more particularly to a method for hydrocarbon recovery using sonic treatment.

2. Background

Current methods for hydrocarbon recovery from cleaning contaminated areas has been a substantially expensive operation. Because of their high viscosity, these hydrocarbons are difficult to recover. As the demand for oil has increased, commercial operations have expanded to recovery of such heavy oil from contaminated areas, based on the fact that may be economically viable only when crude oil prices are high.

A number of methods have been developed for hydrocarbon recovery from contaminated areas, as well as for converting inferior grades of oil, such as heavy oil and bitumen, into a more usable form for refineries.

These methods by which heavy oil may be recovered are still evolving. Improvements in the operational efficiency of these methods may decrease the cost for recovering heavy oils and may be economically viable.

Other methods may turn spilled oil or residue hydrocarbons into high value products, which may be accomplished in an environmentally safe and sensitive manner for the technology applied.

One of the drawbacks from existing methods for removal of solids and liquids from hydrocarbons is the complexity of methods employed and the high cost of processes.

For the forgoing reasons, it may be highly desirable to have a simple and cost effective method for removal of solid, liquid materials, and other contaminants from hydrocarbons substances, which may enable achieving higher performance for cleaning contaminated areas for producing de-asphalted oil and heavy oil fuel.

### SUMMARY

The present disclosure details a method for hydrocarbon recovery from a variety of solid and liquid contaminated sites, including but not limited to hydrocarbon recovery from superfund site cleaning, tank leakages under refineries, tank sludge bottoms, spills on ports, warfare damaged oil wells, well bore spills, one stage removal of sand (macro particulates), coal oil tar clean-up, e.g. cleaning sand pits and removal of oil, in order to convert contaminated oil into de-asphalted oil, and heavy oil fuel output, by removal of contaminants from hydrocarbon substances.

According to one embodiment, implementation of the present disclosure may include a method for extraction of contaminated material, transportation to site, filtering to separate solid and liquid waste materials, including but not limited to inorganic waste and organic waste, in preparation prior to using a proprietary sonic reactor to apply a sonic treatment process, which may include using a solvent to separate de-asphalted oil and heavy oil fuel inside the chamber of sonic reactor.

According to one embodiment, this method may use a novel, simple, cost effective sonication method for hydrocarbon recovery, by removal of solid and liquid materials from hydrocarbon substances using a proprietary sonic reactor, which may be portable, faster and scalable. Current technology may not be scalable, because was designed to work in very large refineries of a scale of about 50,000 barrels using tens of acres of land, while this equipment may be set up in as low of an acre of land.

Additionally, the resulting lower solvent to deasphalted oil (DAO) ratio may make the process compact and smaller, which may be affordable for small and medium producers currently facing high costs, due to the needed of hydrocarbon blending for pipeline transportation, or may have penalties for failure to meet pipeline specifications, as well as the opportunities in markets where upgrading asphalt byproducts may reach premium prices.

The sonic treatment process may include the application of low-frequency, high-amplitude, high energy for an optimal mass transfer. The sonic treatment process may significantly reduce processing time from about six hours up to more than ten hours to about 5 seconds to two minutes depending on the solvent-feedstock mixture being processed.

Before sonication of hydrocarbon substances, this method would generally require a solvent for removal of material in suspension. This solvent may be selected to ensure complete dissolution of oil-soluble components of bitumen.

The method of solvent and asphaltene separation post sonic treatment may provide recovery results in a range of about 92% of the solvent or higher in the initial mix with heavy oil feedstock prior to sonic treatment, leaving a solvent residual in the oil within a range of about 4% to about less than 2%.

Solvent recovery may involve stages for separation of precipitated solvent from asphaltenes, via cyclonic filtration, which may spin at high speed, or other appropriated methods, which may be economical and readily applicable to recover solvents after sonic treatment process.

The solvent recovered may be reused and recycled with added new solvent for the continuous process of production of DAO and removal of asphaltenes and residues. Asphaltenes and residues removed from the heavy oil feedstock may be converted into emulsified fuel, or used for the production of road asphalt, or used as heavy fuel oil. This solvent residual in the oil may be within the expected quality parameters for pipeline transportation and refinery specifications.

Sonic treatment process may improve heavy oil densities by 6 to 15 API from as low as 8 API, reduces viscosities of oil by 99% to pipeline specifications and may reduce sulphur and heavy metals by over 50%, mainly achieved as a result of de-asphalting.

This method may be easy to implement, having a lower production costs for removal of solids, liquids and other contaminants from hydrocarbon substances for production of de-asphalted oil and heavy oil fuel.

In one embodiment, a method for hydrocarbon recovery comprises mixing a heavy oil feedstock and a solvent to form a mixture; applying vibrations to the mixture using a sonic reactor; separating micro particulates, DAO, solvent from the mixture using a cyclonic filter; and separating the mixture using asphaltene conversion to remove asphaltenes and solvent. Mixing the heavy oil feedstock and the solvent may comprise adding new solvent and adding solvent separated from the mixture using cyclonic filtering. The solvent may be a n-alkane solvent. Separating micro particulates may further comprise separating particulates less than 100 μm.

In another embodiment, a method for removal of solids from hydrocarbon substances comprises forming a first mixture of water, hydrocarbon, and micro solid material; combining the first mixture with a solvent; and separating the micro solid material using a sonic reactor to form a second mixture. Forming the first mixture can comprise separating organic waste. The solvent may be a n-alkane solvent. Selecting the solvent can be based upon a desired level of separation of asphaltenes. Separating the micro solid material can further comprise filtering particulates less than 100 μm. Separating the micro solid material can further comprise cyclonic filtering of the first mixture to remove micro particulates. DAO and recovered solvent can be separated. Asphaltenes can be separated from the second mixture to form a third mixture. Recovered solvent can be added in the cyclonic filtering.

In yet another embodiment, a hydrocarbon recovery system comprises a mixer for combining a mixture comprising a heavy oil feedstock and a solvent; a sonic reactor applying vibrations to the mixture; and a cyclonic filter for separating micro particulates, DAO, solvent from the mixture. The mixer can be an in line mixer. The sonic reactor can have a support structure that supports a resonant bar that is configured to vibrate and cause vibration of a reaction chamber housing the mixture. The DAO and solvent can be filtered together.

These and other advantages of the present disclosure may be evident to those skilled in the art, or may become evident upon reading the detailed description of this method, as shown in the accompanying process flow chart.

### BRIEF DESCRIPTION OF DRAWING

A complete understanding of this method may be described in the present disclosure, and its various features, objects and advantages may be better understood from the illustration of the accompanying drawing, incorporated to illustrate and describe a method for hydrocarbon recovery from a variety of oil spills using sonic treatment process.

FIG. 1 illustrates a process flowchart, for hydrocarbon recovery from site cleanings, according to one embodiment.

FIG. 2A depicts an isometric view of sonicator, according to one embodiment.

FIG. 2B depicts a front view of sonicator, according to one embodiment.

FIG. 2C depicts a right plane section of sonicator, according to one embodiment.

FIG. 2D depicts a front plane section of sonicator, according to one embodiment.

### DETAILED DESCRIPTION

In the following detailed description, reference is made to the accompanying process flow chart, which form a part hereof. On this flow chart, which is not to scale or to proportion, similar symbols typically identify similar components, unless context dictates otherwise. The illustrative embodiments described in the detailed description, are not meant to be limiting. Other embodiments may be used and other changes may be made without departing from the spirit or scope of the present disclosure.

### Definitions of Terms

All scientific and technical terms used in the present disclosure have meanings commonly used in the art, unless otherwise specified. The definitions provided here, are to facilitate understanding of certain terms used frequently and are not meant to limit the scope of the present disclosure.

“Sonication” may refer to any device or system which produces vibrational energy sufficient to impact one or more desired end uses.

“Asphaltenes” may refer to materials, present in heavy oils and bitumen's, which precipitate in n-alkanes solvent.

“Bitumen” may refer to a sticky, black and highly viscous liquid or semi-solid form of petroleum, Also known as asphalt. It may be found in natural deposits or may be a refined product.

### DESCRIPTION OF THE DRAWINGS

Method for Hydrocarbon Recovery from Site Cleanings

FIG. 1 illustrates a simplified flowchart process for hydrocarbon recovery structure 100, incorporating a method for removal of solids from hydrocarbon substances from a plurality of contaminated sites, including but not limited to hydrocarbon recovery from superfund site cleaning, tank leakage under refineries, tank sludge bottoms, spills on ports, warfare damaged oil wells, well bore spills, and the like.

The present disclosure may initiate a process for recovery of materials by analyzing content of contaminated hydrocarbons, in step 102, which may include evaluating a mixture of solids and liquids, taking samples for determination of percentage of solid materials in order to select the equipment suitable for extraction of materials, in step 104. Pumps, excavator diggers, conveyors, shovels, and the like may be employed based on a type of material.

Extracted material may require transportation to a site, in step 106, using dump trucks, pipe lines, conveyors or any suitable transportation capable to haul heavy materials to the site, for separation of heavy and small solid materials, followed by filtering, in step 108, which may separate inorganic waste, in step 110, which may be return to landfills, in step 112.

Filtering, in step 108, may also separate organic waste, in step 114, to form a liquid mixture or slurry that may consists of water, hydrocarbon, and fine micro solid material, which may be normally suspended on fuel. Suitable organic waste, in step 114, may be sent to a farmers market, in step 116, so that it may be employed as fertilizer.

Micro solid material that cannot be separated from heavy oil feedstock by any of the foregoing protocols, may require use of n-alkanes solvents in an appropriated ratio, which may precipitate heavy oil feedstock to be processed, in step 118. Solvent ratios may be determined from the level of chemicals contained in selected heavy oil feedstock, a desired level of separation of asphaltenes, and cost factors associated with hydrocarbon recovery structure 100.

Heavy heavy oil feedstock may be statically or dynamically combined with selected solvent to form a stable and optimized mixture employing an in line mixer, in step 120, for proper blending and homogenization, which may be required for efficient sonic treatment, in step 122, employing a proprietary sonic reactor, or sonicator, using a low-frequency/high-energy/high-amplitude reactor design, to separate micro solid materials from mixture, mainly achieved as a result of de-asphalting.

Sonic treatment, in step 122, may allow for significant improvement in the mass transfer efficiency of the DAO+solvent, in step 126, and in particular, may enable recovery of de-asphalted hydrocarbons containing asphaltenes and residues of solvents. The sonic treatment process may significantly reduce the de-asphalting processing time, from a range of 6 hours to about 10+ hours to a range from about 5 seconds to about 2 minutes.

Vibration energy of the cleaning process by sonic treatment, in step 122, may cause micro suspended solids in the fluid to go into solution, and asphaltenes may conglomerate out. It may be desirable to filter micro particulates less than 100 μm by employing a cyclonic filtering of material, in step 124, which may also separate DAO+solvent, in step 126, which may be routed to DAO extraction plant, in step 128, and subsequently to storage tanks (not shown) for final distribution to DAO market, in step 130.

After high speed spinning of cyclonic filtering of material, in step 124, all solid micro particulates may be directed to the bottom of a cyclonic filter along with asphaltenes +impurities +solvent, in step 132, which may be directed to asphaltene conversion, in step 134, for a second separation of materials. Asphaltenes may be directed to an asphalt plant, in step 136, and remaining impurities and solvent may be directed to an emulsification plant, step 138, for separation of heavy oil fuel, in step 140, which may be sent to storage tanks (not shown) to make it available to refineries or other heavy oil markets.

A solvent recovery, in step 142, may direct the recovered solvent to in line mixer, step 120, for subsequently usage with solvent from make up solvent tank 144.

FIG. 2A depicts an isometric view 202, in FIG. 2B shows a front view 204, in FIG. 2C shows right plane section 206, and in FIG. 2D shows front plane section 208. Sonic reactor 200 is shown having support structure 210, resonant bar 212, and a set of magnet configuration 214, resonant bar supports 216, and reaction chamber 218 on each end of resonant bar 212.

Sonic reactor 200 may use support structure 210 to hold resonant bar 212 in place using any suitable support as resonant bar supports 216. Suitable configurations for resonant bar supports 216 may include configurations including a plurality (e.g., three or more) of rubber air cushions. Any suitable magnet configuration 214, activated by a control module (not shown), may cause resonant bar 212 to vibrate, sonicating to heavy oil feedstock in one or more reaction chamber 218. Suitable configurations for magnet configuration 214 include configurations with at least 3 magnets and power suitable to cause resonant bar 212 to vibrate.

Heavy oil feedstock in reaction chamber 218 may have previously been chemically altered to allow the upgrading of heavy oil feedstock in reaction chamber 218, methods for preparing it for such including the addition of one or more solvents.

The period of time needed to upgrade heavy oil feedstocks in reaction chamber 218 may vary in dependence with a number of factors, including the amplitude and frequency of the vibration of resonant bar 212. The amplitude and frequency of the vibration of resonant bar 212 may in turn depend on the mass of resonant bar 212 and the mass of reaction chamber 218.

While various aspects of this method may be described in the present disclosure, other aspects and embodiments may be contemplated. The various aspects and embodiments disclosed here are for purpose of illustration, and are not intended to be limiting with the scope and spirit being indicated by the following claims.

What is claimed is:

1. A method for hydrocarbon recovery comprising:
mixing a heavy oil feedstock and a solvent to form a mixture;
applying vibrations to the mixture using a sonic reactor;
separating micro particulates, DAO, solvent from the mixture using a cyclonic filter; and
separating the mixture using asphaltene conversion to remove asphaltenes and solvent.

2. The method according to claim 1, wherein mixing the heavy oil feedstock and the solvent comprises adding new solvent and adding solvent separated from the mixture using cyclonic filtering.

3. The method according to claim 1, wherein the solvent is a n-alkane solvent.

4. The method according to claim 1, wherein separating micro particulates further comprises separating particulates less than 100 μm.

5. A method for removal of solids from hydrocarbon substances, the method comprising:
forming a first mixture of water, hydrocarbon, and micro solid material;
combining the first mixture with a solvent; and
separating the micro solid material using a sonic reactor to form a second mixture.

6. The method according to claim 5, wherein forming the first mixture comprises separating organic waste.

7. The method according to claim 5, wherein the solvent is a n-alkane solvent.

8. The method according to claim 5, further comprising selecting the solvent based upon a desired level of separation of asphaltenes.

9. The method according to claim 5, wherein separating the micro solid material further comprises filtering particulates less than 100 μm.

10. The method according to claim 5, wherein separating the micro solid material further comprises cyclonic filtering of the first mixture to remove micro particulates.

11. The method according to claim 10, further comprising separating DAO and recovered solvent.

12. The method according to claim 11, further comprising separating asphaltenes from the second mixture to form a third mixture.

13. The method according to claim 11, further comprising adding recovered solvent in the cyclonic filtering.

14. A hydrocarbon recovery system comprising:
a mixer for combining a mixture comprising a heavy oil feedstock and a solvent;
a sonic reactor applying vibrations to the mixture; and
a cyclonic filter for separating micro particulates, DAO, solvent from the mixture.

15. The system according to claim 14, wherein the mixer is an in line mixer.

16. The system according to claim 14, wherein the sonic reactor has a support structure that supports a resonant bar that is configured to vibrate and cause vibration of a reaction chamber housing the mixture.

17. The system according to claim 14, wherein the DAO and solvent are filtered together.
